(19) United States
(12) Patent Application Publication
(10) Pub. No.: US 2003/0117316 A1
(43) Pub. Date: Jun. 26, 2003

(54) Systems and methods for locating and tracking a wireless device

(76) Inventor: Steve Tischer, Tucker, GA (US)

Correspondence Address: MARCUS DELGADO, SENIOR PATENT COUNSEL, BELLSOUTH INTELLECTUAL PROPERTY MANAGEMENT CORPORA, 1155 PEACHTREE STREET, SUITE 500, ATLANTA, GA, 30309, US

(21) Appl. No.: 10/027,215

(22) Filed: Dec. 21, 2001

(51) Int. Cl. G01S 1/00; H04Q 7/20

(52) U.S. Cl. 342/357.1; 455/456

(57) ABSTRACT

Systems and methods for locating and tracking a wireless device including a database remotely located from the wireless device, the database operable for receiving and storing position information from the wireless device at a predetermined interval. The systems and methods also including a wireless network operable for communicating the position information from the wireless device to the database and a first algorithm operable for providing the position information upon request. The systems and methods further including a second algorithm allowing modification of the predetermined interval, a third algorithm operable for associating a landmark with the position information, a fourth algorithm operable for causing the position of the wireless device to be determined locally at the predetermined interval, a fifth algorithm operable for causing the position information to be stored locally within the wireless device, and a sixth algorithm operable for causing the position information to be communicated to the database via the wireless network when the battery power of the wireless device reaches a predetermined level. The position information is provided to a user via a land-line phone and a public switched telephone network (PSTN), a finding wireless device and the wireless network, or a personal computer (PC) and a globally-distributed computer network. The position information is provided to the user in the form of a voice synthetic message, a text message, or a graphical display.

### FIELD OF THE INVENTION

The present invention relates generally to systems and methods for locating and tracking a wireless device and, more specifically, to computerized systems and methods for locating and tracking a wireless device, such as a cellular phone, a pager, a personal digital assistant (PDA), or a laptop computer.

### BACKGROUND

As the number of wireless users increases worldwide, so does the frequency of misplaced, lost, and stolen wireless devices. Such wireless devices may include, for example, cellular phones, pagers, personal digital assistants (PDAs), laptop computers, and the like. As an illustration, it has been estimated by the Gartner Group that about 232,000 lost cellular phones were turned in at the 50 busiest U.S. airports during the year 2000. During the same year, about 35,000 lost PDAs were turned in at those same airports. This problem is compounded by the demand for ever-smaller form factors and the proliferation of the use of wireless devices in public places, such as in airports, restaurants, theaters, concert halls, sporting venues, and the like. This problem also raises serious security concerns, as PDAs and laptop computers, for example, often contain sensitive or confidential information.

A variety of conventional systems and methods exist for locating wireless devices. For example, cellular phones are increasingly equipped with global positioning system (GPS) receivers, land-based location networks exist, and cellular phones may be located using cellular triangulation methods. Some of these systems and methods are becoming requirements so that emergency service callers may be located. For example, the Federal Communications Commission (FCC) requires that by 2002 all wireless service providers be able to report a user's position to within a predetermined distance, this predetermined distance becoming progressively smaller as the requirements are implemented. In fact, state-of-the-art GPSs are now capable of determining the location of a wireless device to within a few inches. The nature of the native services of such devices is also becoming increasingly bi-directional, with the devices increasingly becoming capable of sending and receiving a great deal of current state information.

Although conventional systems and methods allow emergency service workers to locate a wireless device, there is currently no way for a user or other individual to quickly and efficiently locate a misplaced, lost, or stolen device. Thus, what is needed are systems and methods that allow a user to request and purchase a location and tracking service that periodically receives location information from a wireless device and stores this information at a remote location, away from the device. This information may then be retrieved by a user or other individual to locate a misplaced, lost, or stolen device.

### BRIEF SUMMARY

The present invention provides systems and methods for locating and tracking a wireless device. These systems and methods allow a user to request and purchase a location and tracking service that periodically receives location information from a wireless device and stores this information at a remote location, away from the device. Advantageously, the content and quality of such information and the frequency of the data retrieval may be specified by the user, allowing the user to control the relative cost of the services provided. The information may be retrieved by the user or another individual to locate a misplaced, lost, or stolen device. Again, the user has some degree of control with respect to the content and quality of the information that may be retrieved, and with respect to how it may be retrieved. Suitable retrieval methods include, for example, retrieval via a land-line phone, facsimile, another wireless device, and a globally-distributed computer network, such as the Internet. The systems and methods of the present invention may incorporate other features and functionalities, as will be described in further detail herein below.

In one embodiment, a system for locating and tracking a wireless device includes a database remotely located from the wireless device, the database operable for receiving and storing position information from the wireless device at a predetermined interval. The system also includes a wireless network operable for communicating the position information from the wireless device to the database and a first algorithm operable for providing the position information upon request. The system further includes a second algorithm allowing modification of the predetermined interval, a third algorithm operable for associating a landmark with the position information, a fourth algorithm operable for causing the position of the wireless device to be determined locally at the predetermined interval, a fifth algorithm operable for causing the position information to be stored locally within the wireless device, and a sixth algorithm operable for causing the position information to be communicated to the database via the wireless network when the battery power of the wireless device reaches a predetermined level. The position information may be provided to a user via a land-line phone and a public switched telephone network (PSTN), a finding wireless device and the wireless network, or a personal computer (PC) and a globally-distributed computer network. The position information may be provided to the user in the form of a voice synthetic message, a text message, or a graphical display.

In another embodiment, a method for locating and tracking a wireless device includes receiving position information from the wireless device via a wireless network at a predetermined interval, providing a database remotely located from the wireless device, storing the position information in the database, and providing the position information upon request. The method also includes allowing modification of the predetermined interval and associating a landmark with the position information. The method further includes causing the position of the wireless device to be determined locally at the predetermined interval, causing the position information to be stored locally within the wireless device, and causing the position information to be communicated to the database via the wireless network when the battery power of the wireless device reaches a predetermined level. The position information is provided to a user via a land-line phone and a public switched telephone network (PSTN), a finding wireless device and the wireless network, or a personal computer (PC) and a globally-distributed computer network. The position information is provided to the user in the form of a voice synthetic message, a text message, or a graphical display.

### BRIEF DESCRIPTION OF THE DRAWINGS

FIG. 1 is a schematic diagram of one embodiment of the operating environment of the wireless device location and tracking system and method of the present invention;

FIG. 2 is a schematic diagram of one embodiment of a portion of the operating environment of the wireless device location and tracking system and method of the present invention, highlighting a wireless service provider's facility and the associated components; and

FIG. 3 is a flow chart of one embodiment of the wireless device location and tracking method of the present invention.

### DETAILED DESCRIPTION

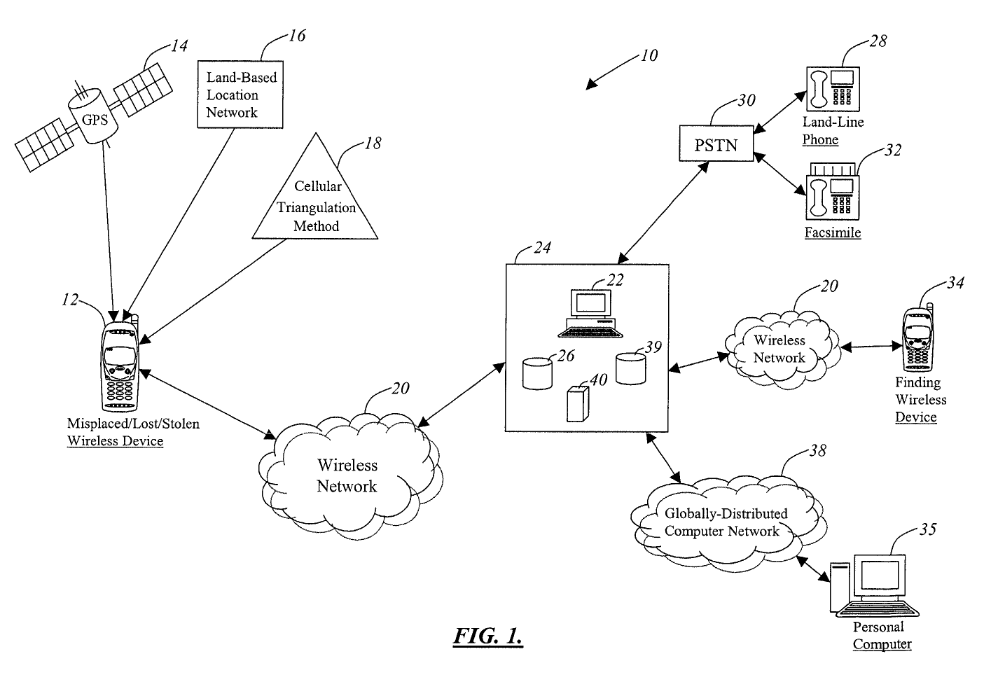

Referring to FIG. 1, in one embodiment, a system 10 according to the present invention includes a wireless device 12, which may be misplaced, lost, or stolen. The wireless device 12 may be, for example, a cellular phone, a pager, a personal digital assistant (PDA), a laptop computer, or the like. The “wireless device” 12 may also be any other fixed or movable asset for which tracking is desired. Preferably, the wireless device 12 is capable of locally determining its location or position in at least one of a variety of ways. For example, the wireless device 12 may include a global positioning system (GPS) receiver and utilize GPS 14 to determine its latitude, longitude, altitude, and direction of movement, if any. Alternatively, the wireless device 12 may include a receiver operable for communicating with a land-based location network 16. The wireless device 12 may also be capable of determining its location or position utilizing a cellular triangulation method 18, well known to those of ordinary skill in the art. Initially, the location or position of the wireless device 12 is stored locally in a position buffer or database disposed within a memory of the wireless device 12.

Through a wireless network 20, the wireless device 12 is in communication with a computer 22 located within a wireless service provider's facility 24. The wireless device 12 periodically communicates its location or position to the computer 22. For example, in the case of a cellular phone, the device 12 may simply call the computer 22 at a predetermined interval and communicate its location or position to the computer 22. In the case of a PDA or a laptop computer, the device 12 utilizes a modem to communicate its location or position to the computer 22. This location information is stored in a database 26 associated with the computer 22. The location database 26 may continuously update the location information received from the wireless device 12, rewriting the location information, or it may keep a running list of successive locations or positions. Advantageously, the location database 26 is remotely located from the wireless device 12, such that if the wireless device 12 is misplaced, lost, or stolen, the location information is preserved in a safeguarded location.

Because the wireless device 12 shown only communicates its location or position to the computer 22 when the device 12 has battery power or when the device 12 is turned-on, the wireless device 12 has a wake-up mode or a remote-on capability. In the wake-up mode, the memory of the wireless device 12 contains an algorithm that is operated on by a processor of the wireless device 12 to wake-up the wireless device 12 if it is turned-off so that the wireless device 12 may communicate its location or position to the computer 22. The remote-on capability allows the wireless device 12 to be remotely activated, or “pinged” via a wireless local-area network (LAN) or wide-area network (WAN) for communication purposes. The signal strength relative to the distance of the wireless device 12 from a receiving antenna or a cellular tower may be used to estimate the remaining battery power of the device 12. Optionally, the wireless device 12 includes an “if-then comparator,” such that if the wireless device 12 moves n units then the location information is stored locally in the position buffer or database. However, if the wireless device 12 moves 2n units then the location information is communicated to the computer 22 and the location database 26 via the wireless network 20.

The wireless device 12 and wireless network 20 may utilize any suitable protocol or system. For example, the wireless network 20 may transmit information via any suitable method, such as a frequency division multiple access (FDMA) method, a time division multiple access (TDMA) method, or a code division multiple access (CDMA) method. The wireless network 20 may utilize any suitable communications standard, such as an advanced mobile phone system (AMPS) standard, a narrowband advanced mobile phone service (NAMPS) standard, or a global system for mobile communications (GSM) standard. Further, the wireless device 12 may be any generation device, such as a second-generation (2G) device, a second-and-a-half-generation (2½ G) device, or a third-generation (3G) device. The wireless network 20 may utilize any suitable network system, such as a personal communications service (PCS)-based system or an integrated digital enhanced network (IDEN).

The wireless device 12 may communicate its location or position to the computer 22 via a transmission band other than the primary transmission band of the device 12, and may utilize any suitable transmission band. For example, the wireless device 12 may piggyback on the 9-1-1 infrastructure, or the device 12 may utilize Bluetooth (Bluetooth Special Interest Group (SIG)) or any other suitable peer-to-peer method to communicate its location or position to wireless devices in its proximity or to tell wireless devices in its proximity that it is in trouble (e.g. low on battery power or apparently misplaced, lost, or stolen). The wireless device 12 and wireless network 20 may also send location information packets to Internet protocol (IP)-based service networks. Accordingly, each wireless device 12 may have a unique identifier, including a hardware address and an IP address. When connectivity is available to any suitable IP network via local or broadband wireless techniques, such as Bluetooth or 802.11 protocols, the required information is transmitted over the network.

Preferably, the location information may be requested by a user of the wireless device 12 or another individual in one or all of a variety of ways. For example, the user may request the location information via a land-line phone 28 and the public switched telephone network (PSTN) 30. The PSTN 30 is the aggregate of all lines and equipment serving to connect phone users, excluding private networks formed from leased phone lines, wireless networks, and public data networks, such as the Internet. The user may also request the location information via a facsimile machine 32 and the PSTN 30. The user may further request the location information via a second, finding wireless device 34 and the wireless network 20, or via a personal computer (PC) 36 and a globally-distributed computer network 38, such as the Internet. The PC 36 communicates with the computer 22 and the location database 26 through the globally-distributed computer network 38 with the aide of a server 40. The server 40 may be, for example, a database server, a web server, an application server, or the like. The location information may automatically be sent to the user periodically via facsimile or email, or when the wireless device 12 indicates that it is in trouble (via failure to communicate and the like).

When the location of a wireless device 12 needs to be determined—as when a user has misplaced or lost the device 12, or the device 12 has been stolen—a request is made to the wireless service provider, an appropriate algorithm is accessed, and a report is generated, providing the most recent known location of the device 12. The format of the report is determined by an initial profile established by the user at the time the location and tracking service was originally requested, or by the user's response to a format query. For example, location information requested via a land-line phone 28 or finding wireless device 34 may take the form of a voice synthetic message advising the user of the most recent known location of the wireless device 12 and, optionally, landmarks in close proximity to the most recent known location of the device 12. These landmarks may be obtained from a database 39 of predetermined sites (such as street names or sites on a map), or they may be obtained from a database 39 of sites established by the user at the time the location and tracking service was originally requested. A sample voice synthetic message for a cellular phone may be: “Your [make and model] phone, registered with [wireless service provider], is likely at your [site established by the user] as of [date and time].” The “site established by the user” may be, for example, “within fifty (50) feet of your summer home.” Location information requested via facsimile 32, a finding wireless device 34 having a graphical user interface or display, or a PC 36 may take the form of text, a map, or a web page link to a map describing or showing the most recent known location of the wireless device 12. The specificity of the location information and the format of the report are controlled by the user profile and may be modified at any time. In order to obtain a report, suitable authentication information must be inputted. The entire location and tracking process is preferably automated.

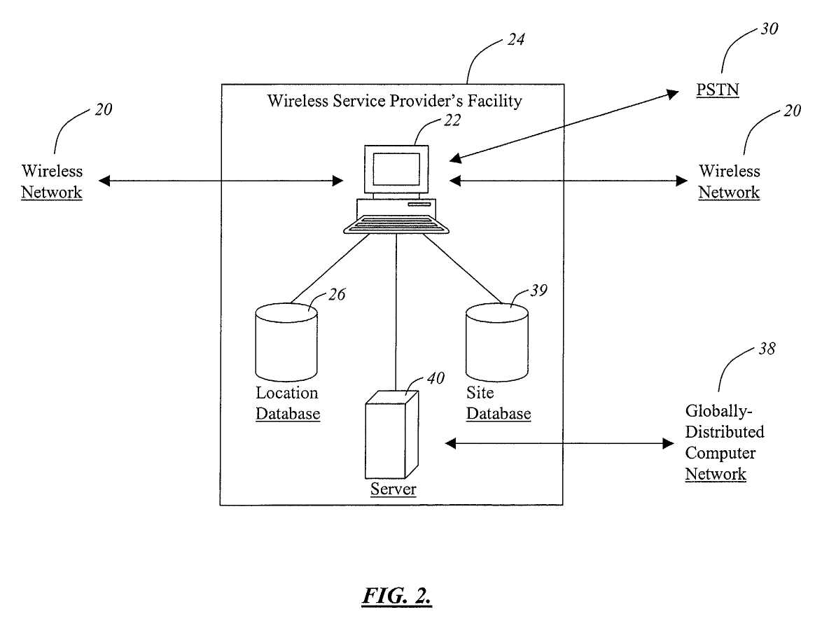

An exemplary embodiment of the wireless service provider's facility 24 and the associated components is illustrated in FIG. 2. The wireless service provider's facility 24 preferably includes the computer 22 in communication with the location database 26, the site database 39, and the server 40. The computer 22 is also in communication with the wireless network 20 and the PSTN 30. The server 40 is further in communication with the globally-distributed computer network 38.

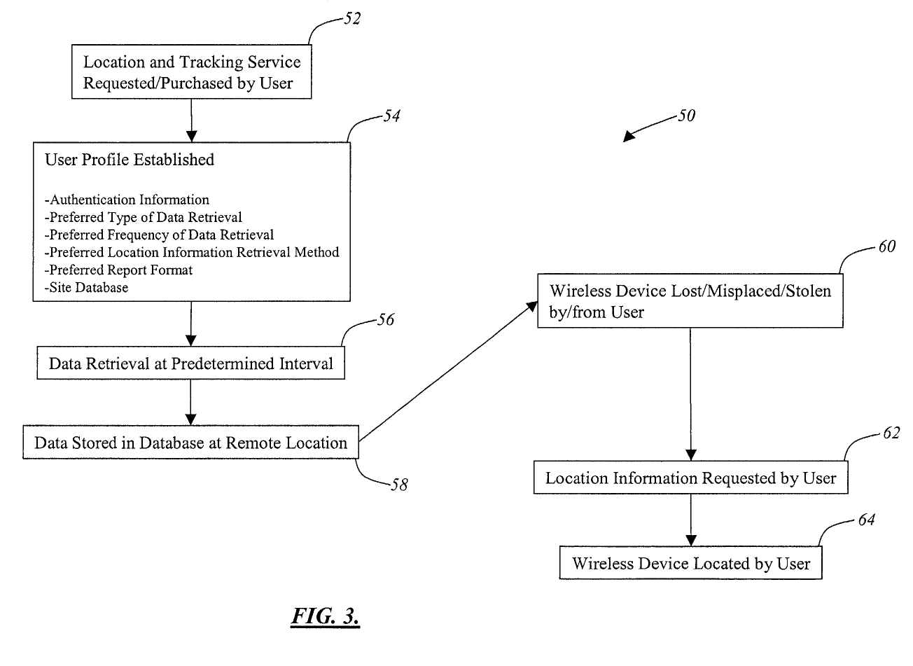

Referring to FIG. 3, in one embodiment, the method 50 of the present invention includes a request for and the purchase of the location and tracking service by a user (Block 52). A user profile is then established (Block 54). The user profile may include, for example, authentication information (biographical and contact information, a username and/or a password, and the like), the preferred type of data retrieval (latitude, longitude, altitude, direction of movement, and the like), the preferred frequency of data retrieval (per second, per minute, per hour, per day, and the like), the preferred location information retrieval method (land-line phone 28, facsimile 32, wireless device 34, PC 36, and the like), the preferred report format (voice synthetic message, text, a map, a web page link to a map, and the like), and a site database 39 (home, office, landmarks, and the like). Once the location and tracking service is established, the computer 22 and the location database 26 located within the wireless service provider's facility 24 periodically retrieve location information from the wireless device 12 at the established predetermined interval (Block 56). This location information is stored in the location database 26 which, preferably, is remotely located, away from the wireless device 12 (Block 58). If the wireless device 12 is then misplaced or lost by the user (Block 60), the user may request the location information in one of the variety of ways described above (Block 62). The location information is then used by the user or another individual to locate the wireless device 12 (Block 64).

The systems and methods of the present invention may also incorporate other advantageous features and functionalities. For example, the accuracy of the latitude, longitude, altitude, and direction of movement data may be increased or decreased at an increased cost or at a decreased cost to the user, respectively. Likewise, the preferred frequency of data retrieval may also be increased or decreased. In addition, any number of previous location data points may be stored, providing a method of plotting movement along a course. As a result, current location information may be extrapolated in the absence of a current location data point.

If a finding wireless device 34 is used to locate a misplaced, lost, or stolen wireless device 12, an acknowledgment response mode may be designed to sound a pitch in the finding wireless device 34 when it is in close proximity to the misplaced, lost, or stolen wireless device 12. If the finding wireless device 34 has directional capabilities, the pitch may change when the finding wireless device 34 is pointed towards the misplaced, lost, or stolen wireless device 12. The pitch may also change when the finding wireless device 34 moves closer to the misplaced, lost, or stolen wireless device 12.

With respect to rich-media-enabled wireless devices 12, a variety of media may be communicated to the computer 22 and the location database 26 located within a wireless service provider's facility 24. For example, a cellular phone may record and transmit a piece of audio every hour. A video-enabled cellular phone may record and transmit a video frame every hour. The more location information provided by the misplaced, lost, or stolen wireless device 12, the more helpful the information is to a user attempting to locate the device 12.

The systems and methods of the present invention may also include and work in conjunction with a safety mode for a wireless device 12. The safety mode directs the wireless device 12 to enter a low power-use mode, a sleep mode, or a shut-down mode during periods of device inactivity. An electronic wake-up call or a password are preferably required to inactivate or cancel the safety mode. The safety mode ensures that phone numbers in the memory of a cellular phone remain private, files in the memory of a PDA or laptop computer remain private, and security is maintained in general. Optionally, the wireless device 12 is solar-powered.

It is apparent that there have been provided, in accordance with the present invention, systems and methods for locating and tracking a wireless device. While the present invention has been shown and described in conjunction with examples and preferred embodiments thereof, variations in and modifications to the present invention may be effected by those of ordinary skill in the art without departing from the spirit or scope of the invention. For example, although the present invention has shown and described systems and methods for locating and tracking wireless devices, such as cellular phones, pagers, PDAs, and laptop computers, the systems and methods of the present invention may also be used to locate and track individuals, vehicles, or anything else which may be provided with and utilize a location means and a wireless communication means. It is therefore to be understood that the principles described herein apply in a similar manner, where applicable, to all examples and preferred embodiments and the following claims are intended to cover all such equivalents.

What is claimed is:

1. A system for locating and tracking a wireless device, the system comprising:
a database remotely located from the wireless device, the database operable for receiving and storing position information from the wireless device at a predetermined interval;
a wireless network operable for communicating the position information from the wireless device to the database; and
a first algorithm operable for providing the position information upon request.

2. The system of claim 1, wherein the first algorithm is operable for providing the position information to a user upon the request of the user.

3. The system of claim 1, further comprising a second algorithm allowing a user to modify the predetermined interval.

4. The system of claim 1, wherein the position information comprises position information selected from the group consisting of latitude, longitude, altitude, direction of movement, an audio representation of position, and a video representation of position.

5. The system of claim 1, further comprising a third algorithm operable for associating a landmark with the position information.

6. The system of claim 5, wherein the first algorithm is further operable for providing information related to the associated landmark to a user.

7. The system of claim 1, wherein the position information is provided to a user via a land-line phone and a public switched telephone network (PSTN), the land-line phone and the PSTN in communication with the database.

8. The system of claim 1, wherein the position information is provided to a user via a finding wireless device and the wireless network, the finding wireless device and the wireless network in communication with the database.

9. The system of claim 1, wherein the position information is provided to a user via a personal computer (PC) and a globally-distributed computer network, the PC and the globally-distributed computer network in communication with the database.

10. The system of claim 1, wherein the position information is provided to a user in the form of a voice synthetic message.

11. The system of claim 1, wherein the position information is provided to a user in the form of a text message.

12. The system of claim 1, wherein the position information is provided to a user in the form of a graphical display.

13. The system of claim 1, wherein the wireless network comprises an Internet protocol (IP)-based service network.

14. The system of claim 1, further comprising a fourth algorithm operable for causing the position of the wireless device to be determined locally at the predetermined interval.

15. The system of claim 14, further comprising a fifth algorithm operable for causing the position information to be stored locally within the wireless device.

16. The system of claim 1, further comprising a sixth algorithm operable for causing the position information to be communicated to the database via the wireless network when the battery power of the wireless device reaches a predetermined level.

17. The system of claim 1, wherein the wireless device comprises a wireless device selected from the group consisting of a cellular phone, a pager, a personal digital assistant (PDA), and a laptop computer.

18. A method for locating and tracking a wireless device, the method comprising:
at a predetermined interval, receiving position information from the wireless device via a wireless network;
providing a database remotely located from the wireless device;
storing the position information in the database; and
upon request, providing the position information.

19. The method of claim 18, wherein providing the position information further comprises providing the position information to a user upon the request of the user.

20. The method of claim 18, further comprising allowing a user to modify the predetermined interval.

21. The method of claim 18, wherein the position information comprises position information selected from the group consisting of latitude, longitude, altitude, direction of movement, an audio representation of position, and a video representation of position.

22. The method of claim 18, further comprising associating a landmark with the position information.

23. The method of claim 22, further comprising providing information related to the associated landmark to a user.

24. The method of claim 18, wherein the position information is provided to a user via a land-line phone and a public switched telephone network (PSTN), the land-line phone and the PSTN in communication with the database.

25. The method of claim 18, wherein the position information is provided to a user via a finding wireless device and the wireless network, the finding wireless device and the wireless network in communication with the database.

26. The method of claim 18, wherein the position information is provided to a user via a personal computer (PC) and a globally-distributed computer network, the PC and the globally-distributed computer network in communication with the database.

27. The method of claim 18, wherein the position information is provided to a user in the form of a voice synthetic message.

28. The method of claim 18, wherein the position information is provided to a user in the form of a text message.

29. The method of claim 18, wherein the position information is provided to a user in the form of a graphical display.

30. The method of claim 18, wherein the wireless network comprises an Internet protocol (IP)-based service network.

31. The method of claim 18, further comprising providing a first algorithm operable for causing the position of the wireless device to be determined locally at the predetermined interval.

32. The method of claim 31, further comprising providing a second algorithm operable for causing the position information to be stored locally within the wireless device.

33. The method of claim 18, further comprising causing the position information to be communicated to the database via the wireless network when the battery power of the wireless device reaches a predetermined level.

34. The method of claim 18, wherein the wireless device comprises a wireless device selected from the group consisting of a cellular phone, a pager, a personal digital assistant (PDA), and a laptop computer.
